(19) United States
(12) Patent Application Publication
(10) Pub. No.: US 2010/0265039 A1
(43) Pub. Date: Oct. 21, 2010

(54) Systems and Methods for Securing Control Systems

(75) Inventors: Samuel L. Clements, Richland, WA (US); Thomas W. Edgar, Richland, WA (US); Mark D. Hadley, Kennewick, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/425,979

(22) Filed: Apr. 17, 2009

(51) Int. Cl. G05B 19/00

(52) U.S. Cl. 340/5.83

(57) ABSTRACT

A system and a method for securing control systems for critical infrastructure, complex networks and/or industrial processing facilities. Aspects of the invention can include a proximity-based user identification device that generates a computer-readable identification of operators who are in proximity to a control device in the control system and an imaging device that captures a visual likeness of operators in proximity to the control device. A network sensor can read operation data from the control system. An overlay network can interconnect the proximity-based identification device, the imaging device, and the network sensor, and can interface to the control system without modifying the control system. Processing hardware can execute processor-implemented instructions to generate a correlation between at least a portion of the operation data and the control system, the computer-readable identification, and the visual likeness. The processor can then associate the correlation with the portion of the operation data.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

Security is a clear and critical requirement for systems that control critical infrastructure (e.g., electrical power, water, transportation, communication, etc.), complex networks, and/or industrial processing facilities. For example, in such control systems the identity of an operator would ideally be determined and validated prior to being given access in order to ensure that only authorized personnel interact with the control system. The prior art describes a number of solutions for authentication and/or identity verification. However, they are typically not appropriate for the control systems described herein. The operational requirements of the instant control systems require them to be ready for use at all times. Prior art solutions involving user accounts and passwords, and other authentication approaches, for access are not feasible because the time required to authenticate (e.g., login/logout) different users is unacceptable in this environment. However, industry, government, and/or corporate regulations may specify that the operators of the control system must be accurately identified. Therefore, a problem arises in auditing events on a system having little to no accountability. Clearly, a need exists to secure such control systems and to identify operators without requiring log on activities and individual user accounts, or other time-consuming authentication processes exists.

### SUMMARY

The present invention is a system and a method for securing control systems for critical infrastructure, complex networks and/or industrial processing facilities. The control system is secured by identifying users, documenting operator activities, and detecting remote compromise. The present invention can involve location analysis, network-enabled imaging, and network monitoring to correlate and operator's location, machine location, and operator access rights, and, in some embodiments, to control network traffic in the control system.

In particular, the present invention can comprise a proximity-based user identification device that generates a computer-readable identification of operators who are in proximity to a control device in the control system and an imaging device that captures a visual likeness of operators in proximity to the control device. A network sensor can read operation data from the control system. An overlay network can interconnect the proximity-based identification device, the imaging device, and the network sensor, and can interface to the control system without modifying the control system. Processing hardware can execute processor-implemented instructions to generate a correlation between at least a portion of the operation data and the control system, the computer-readable identification, and the visual likeness. The processor can then associate the correlation with the portion of the operation data. In some embodiments the processing hardware can execute instructions to log in a data storage device the operations data, the computer-readable identification, and the visual likeness that are correlated with one another.

In preferred embodiments the proximity-based identification device is not a log-in/log-out authentication device nor does in introduce any time delay in the interaction between an operator and the control system.

In some embodiments, the imaging device is not a constant video monitoring device. In another embodiment the imaging device and the proximity-based user identification device can be a combined apparatus that employs a facial recognition algorithm. The imaging device can capture the visual likeness of an operator and, by employing a facial recognition algorithm, the identity of the operator can be determined from the visual likeness.

In still another embodiment the network sensor can be configured to block operation data that is not correlated with a computer-readable identification, a visual likeness, or both.

As used herein, the control system can refer to the hardware and software used to control the critical infrastructure, complex networks, and/or industrial processing facilities and the processes associated therewith. In addition to workstations, sensors, actuators, etc., that allow operators to issue commands and/or to monitor the state of the critical infrastructure, complex networks, and/or industrial processing facilities, the control system can include a control network linking the components in the control system. The control network can further link with components that compose the critical infrastructure, complex networks, and/or industrial processing facilities. Operation data from and/or between components can be communicated through the control network. Exemplary components can include, but are not limited to, unit process equipment, facility equipment, sensors, and infrastructure hardware.

Operation data as used herein can refer to data concerning the control, the state, the health, or the conditions in, of, and around the critical infrastructure, complex networks, and/or industrial processing facilities. For example, in an electric power grid, operation data can comprise telemetered data from the supervisory control and data acquisition (SCADA) system and contingency scenarios.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is an illustration depicting a security system according to one embodiment of the present invention.

FIG. 2 is a flowchart depicting one embodiment of the present invention.

### DETAILED DESCRIPTION

The following description includes the preferred best mode of one embodiment of the present invention. It will be clear from this description of the invention that the invention is not limited to these illustrated embodiments, but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

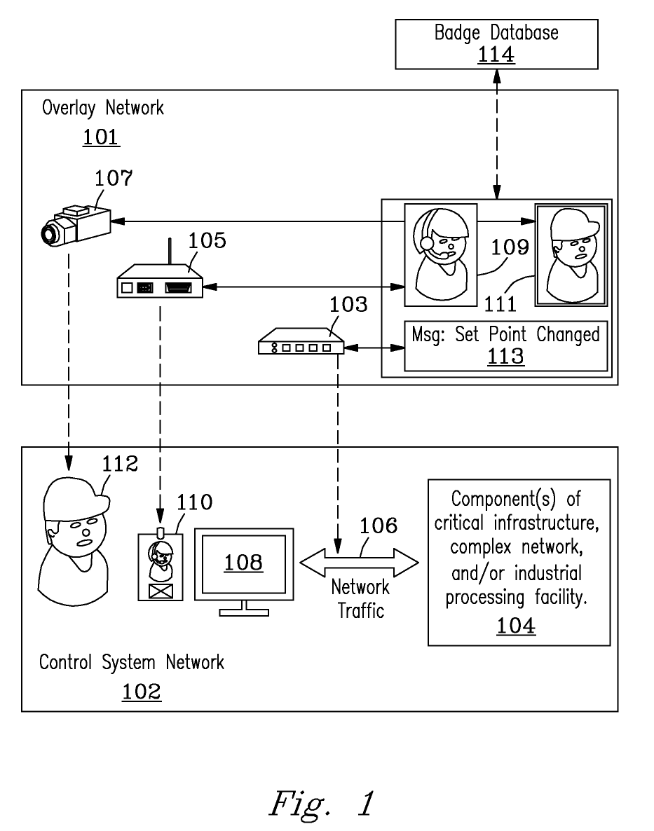

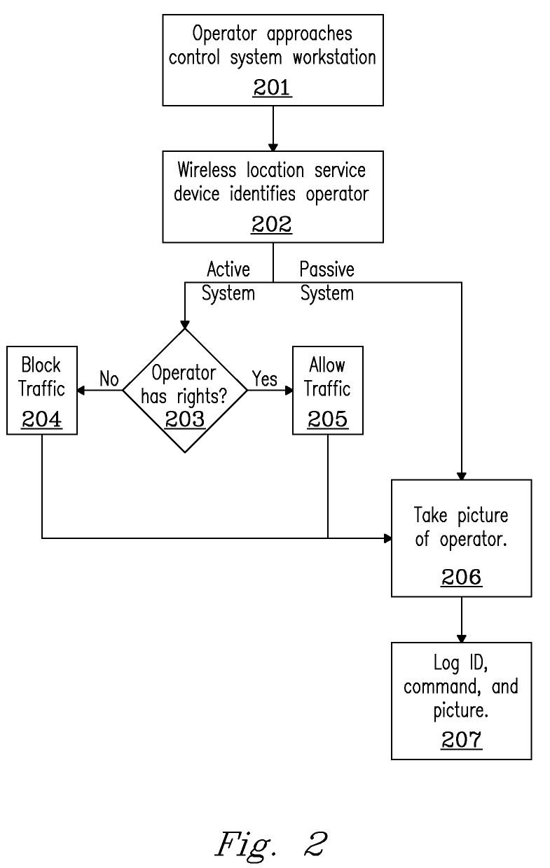

FIGS. 1 and 2 show embodiments of the present invention. Referring first to FIG. 1, an illustration depicts a security system as an overlay network 101 interfaced to a control system network 102, according to embodiments of the present invention. The control system network interlinks components 104 in a critical infrastructure, complex network, and/or industrial processing facility. An operator 112 accessing a workstation 108 can be wirelessly identified by an authenticator 105 according to his badge, which, for example, can contain an RF tag. The authenticator generates a computer-readable identification 109 of the operator based on a RF tag, which can be embedded in a badge 110 worn by the operator. A badge database 114 can contain a list of all authorized operators. In some embodiments, the badge database can also contain access permission levels associated with each operator. Operators would only be able to access control system functions based on their permission level.

A camera 107 that is part of the security system and is located proximal to the workstation can also capture as an image 111 the visual likeness of the operator accessing the workstation. Operation data 106 from the control system network can be monitored and validated by a network sensor 103. For example, prior to execution by the control system, a command 113 sent from a workstation 110 would need to be associated with at least a visual likeness 111, and a computer-readable identification 109 each correlated with one another. The security system monitors the operation data communicated through the control system network. For portions and types of operation data so designated, the security system will block traffic if it is not properly associated with correlated computer-readable identifications and/or visual likenesses. Alternatively, the security system can allow all traffic while generating and storing a log of the operation data. The log can later be audited to verify that only authorized operators had accessed the control system.

Association of commands with visual likenesses acquired at the time commands are issued is also a way of verifying that commands were not issued remotely because an image of the operator issuing the command from the workstation has been stored and associated. Furthermore, if no image is associated with a command, suggesting remote compromise of the control system, the security system can log the incident and send an alert via email, text message, voice message, and/or other communications means.

Furthermore, in some embodiments, various access permissions can be set for each computer-readable identification. When a particular operator approaches a workstation in the control system network, the authenticator will identify the operator according to his RF tag. The security system, can then determine the level of access granted to the operator based on his pre-determined permission level.

Referring to FIG. 2, a diagram depicts one embodiment of a process of identifying operators that access a control system for critical infrastructures, complex networks, and/or industrial processing facilities. An operator with an RF tag embedded into their physical credentials approaches 201 a workstation. A wireless location service device identifies 202 the operator as being in the proximity of the workstation. The security monitor determines what rights 203 the operator has on the control system network. Depending on the access rights of the operator, the security monitor configures the security appliance to allow 205 or block 204 traffic from the operator's workstation. Each command sent from the workstation can be validated. If an authorized operator is present, then the command will be allowed. If not, the command will be blocked and a flag raised. A security camera can take a picture at the workstation every time a command is issued 206. The picture aids in determining who issues a command as well as determine if a command is entered remotely. If the identification, access rights, picture, and command are validated, then the authorized traffic is allowed through to the control system. Otherwise, it can be blocked by the security system. The command, the operator ID and the picture are logged and stored 207.

In the embodiments described herein, the security system does not adversely impact or modify the control system. It allows operation, regulatory, and cyber security requirements to be met in a manner such that they do not adversely affect each other. The security system is also designed to be transparent to the user. In a preferred embodiment, these features are enabled, at least in part, by utilizing a passive Intrusion Detection System, a database, a managed switch with a span port or a network tap, tagging equipment (e.g., tags, antennas and tag readers), and IP enabled cameras. User configurable rules are installed into the Intrusion Detection System that denote which network traffic should be flagged for processing by the system. When the intrusion detection system flags an event it updates a table in the database. A script has been installed into the database that is triggered to run whenever an update is performed on the event table. The script, using the unique event identifier, communicates with the camera corresponding to the event to retrieve a snapshot and with the tagging reader to collect which tags are in the vicinity of the event-actuating workstation. If no tags are present an alert is sent to a user defined location. The script stores information in the database to correlate the event with the picture and tags.

Alternatively, when operating in an active mode, in which unauthorized traffic is blocked, an application level firewall that can block specific types of operations data (e.g., commands) is added to the security system. All traffic deemed critical by the user is blocked by the application level firewall when idle. The Tag reader will notify an application when a tag is seen at a workstation. The application will check access control rules for the tag. The application will change the firewall nileset to allow the traffic for which the tag is authorized. When the user sends a command the passive intrusion detection process described elsewhere herein occurs if the firewall blocks something an alert is sent to a user defined location.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A security system for identifying operators accessing a control system for critical infrastructure, complex networks, and/or industrial processing facilities, the security system comprising:
A proximity-based user identification device that generates a computer-readable identification of operators who are in proximity to a control device in the control system;
An imaging device that captures a visual likeness of operators in proximity to the control device;
A network sensor that reads operation data from the control system;
An overlay network interconnecting the proximity-based identification device, the imaging device, and the network sensor, wherein the overlay network is interfaced to the control system without modifying the control system; and
Processing hardware executing processor-implemented instructions to generate a correlation between at least a portion of the operation data in the control system, the computer-readable identification, and the visual likeness and to associate the correlation with the portion of the operation data.

2. The security system of claim 1, wherein the proximity-based identification device is not a login/logout authentication device.

3. The security system of claim 1, further comprising synchronization hardware to activate tie imaging device when predetermined actions are performed in the control system by the operator.

4. The security system of claim 1, wherein the imaging device is not a constant video monitoring device.

5. The security system of claim 1, wherein the imaging device and the proximity-based user identification device is a combined apparatus employing a facial recognition algorithm.

6. The security system of claim 1, wherein the network sensor is configured to block operation data that is not correlated with a computer-readable identification, a visual likeness, or both.

7. The security system of claim 1, wherein the processing hardware executes processor-implemented instructions to log in a data storage device the operation data, the computer-readable identification, and the visual likeness that are correlated with one another.

8. A method for identifying operators accessing a control system for critical infrastructure, complex networks, and/or industrial processing facilities, the method comprising:
Generating a proximity-based, computer-readable identification of an operator who is located in proximity to a control device in the control system;
Capturing a visual likeness of the operator who is located in proximity to the control device;
Reading operation data from the control system;
Generating a correlation between at least a portion of the operation data in the control system, die computer-readable identification, and the visual likeness without modifying the control system; and
Associating the correlation with the portion of the operation data.

9. The method of claim 8, wherein the computer-readable identification is not a login/logout authentication.

10. The method of claim 8, further comprising synchronizing said generating the computer-readable identification and said capturing the visual likeness to occur when predetermined actions are performed in the control system by the operator.

11. The method of claim 8, wherein said capturing the visual likeness is not constantly monitoring operators with video.

12. The method of claim 8, wherein said generating the computer-readable identification and said capturing the visual likeness occur substantially together by employing a facial recognition algorithm.

13. The method of claim 8, further comprising blocking operation data that is not correlated with a computer-readable identification, a visual likeness, or both.

14. The method of claim 8, further comprising logging the correlation between the operation data, the computer-readable identification, and the visual likeness in a data storage device.
